(19) United States
(12) Patent Application Publication
(10) Pub. No.: US 2015/0133105 A1
(43) Pub. Date: May 14, 2015

(54) MOBILE TERMINAL SETTINGS SWITCHING SYSTEM

(71) Applicant: SPREADTRUM COMMUNICATIONS (SHANGHAI) CO., LTD., Shanghai (CN)

(72) Inventor: Shan JIANG, Shanghai (CN)

(73) Assignee: SPREADTRUM COMMUNICATIONS (SHANGHAI) CO., LTD

(21) Appl. No.: 14/320,938

(22) Filed: Jul. 1, 2014

(30) Foreign Application Priority Data
Nov. 14, 2013 (CN) 2013/10567169.0

(51) Int. Cl. H04W 8/24; H04W 64/00

(52) U.S. Cl. CPC H04W 8/245; H04W 64/00; H04W 88/02
USPC 455/419

(57) ABSTRACT

The present invention discloses a mobile terminal settings switching system. The mobile terminal settings switching system comprises a positioning module, a storage module and an execution module. The execution module is connected to the positioning module and the storage module respectively. The positioning module is used for acquiring the current geographic location information of the mobile terminals. The storage module stores a first record which corresponds to each geographic location information and comprises a set of setting parameters; according to the geographic location information acquired by the positioning module, the execution module extracts the corresponding setting parameters which are stored in the storage module, and the corresponding parameters are applied to the mobile terminals. The parameters of the mobile terminals are automatically switched by positioning the geographic location without manual switching, which saves the operation time, improves the operating efficiency and the users' experiences.

### CROSS-REFERENCE TO RELATED APPLICATIONS

The present application claims priority to and the benefit of Chinese Patent Application No. CN 201310567169.0, filed on Nov. 14, 2013, the entire content of which is incorporated herein by reference.

### BACKGROUND OF THE INVENTION

1. Field of the Invention

The present disclosure relates to the mobile terminal field, more specifically, to a mobile terminal settings switching system.

2. Description of the Related Art

The mobile terminals are widely adopted as the communication tools in the daily life. Generally, the mobile terminals, especially the mobile phones would be carried by the users for the whole day. Meanwhile, the number of the consumers is increasing. A growing number of people become potential users of the mobile terminals, from the aged and the youth. Therefore, the various setting methods are required at different venues and/or times. For instance, it is necessary for the users to set the mobile terminals to silent mode while they are in the working condition. And the mobile terminal would be set to flight mode in the night. Likewise, the additional entertainment function of the mobile terminals (e.g., the Web-Surfing, Music Play, SMS) should be turned off by the students in the school class in order to prevent the class from being disordered. In the prior art, the users have to manually change the set of the parameters while they are at different times and venues. Simultaneously, some parameters are set up in different operation interface by the users. Hence, the operation is not convenient to the users and it will affect using experience thereof.

Chinese Patent No. CN102368798A disclosed a mobile phone setting control system, a control method thereof, a mobile phone setting method, an apparatus thereof and a mobile phone. The system comprises a cloud terminal and a mobile phone, wherein, the cloud terminal packages a received mobile phone setting control instruction sent by a user, carries out encryption according to a preset encryption algorithm, and sends an encrypted mobile phone setting control instruction data packet to the mobile phone, the mobile phone receives the encrypted mobile phone setting control instruction data packet, carries out decryption and parsing on the data packet, and calls a mobile phone system API to carry out control operation on a setting assigned by the mobile phone setting control instruction. The above-mentioned solution merely relates to a mobile phone setting control method that is operated by the users and it does not solve the existing problems in the prior art.

Chinese Patent No. CN102148893A disclosed a method for setting a calling ring of a mobile phone, which can be realized through three steps: After a mobile phone user ‘A’ successfully sets a calling ring for a mobile phone user ‘B’, when the mobile phone user ‘A’ calls the mobile phone user ‘B’, a mobile phone of the mobile phone user ‘B’ searches the corresponding calling ring set by the mobile phone user ‘A’ in an information management library of the mobile phone user ‘B’, and plays the searched ring on the mobile phone of the mobile phone user ‘B’. The above-mentioned solution merely relates to a method for manually setting a calling ring of a mobile phone, which can not solve the existing problems in the prior art.

### SUMMARY OF THE INVENTION

According to the problem that the mobile terminal can not switch the settings parameters automatically in different places or in different time, the present invention provides a mobile terminal settings switching system comprising:

A mobile terminal settings switching system, which is applied to mobile terminals, comprises a positioning module, a storage module and an execution module;

the execution module is connected to the positioning module and the storage module respectively;

the positioning module means for acquiring the current geographic location information of the mobile terminals;

a plurality of settings parameters sets corresponding to each of the geographic location information are stored by the storage module;

each of the settings parameters sets comprises a plurality of corresponding parameters;

according to the geographic location information acquired by the positioning module, the execution module extracts the corresponding set of the settings parameters stored by the storage module, and the set of the corresponding parameters is applied to the mobile terminals.

Preferably, mobile terminal settings switching system, wherein the positioning module comprises a positioning unit and a timing unit; the positioning unit is connected to the timing unit; the positioning unit is used for positioning the mobile terminals to acquire the corresponding geographic location information; a preconfigured first time interval is provided in the timing unit; the positioning unit acquires the geographic location information of the mobile terminals at every preconfigured first time interval.

Preferably, mobile terminal settings switching system, further comprising: an input module connected to the storage module; the input module is supplied for the users to set the geographic location information and to set the set of settings parameters which corresponds to the geographic location information; the geographic location information and the set of settings parameters corresponding to the geographic location information are stored in the storage module by the input module.

Preferably, mobile terminal settings switching system, wherein the storage module comprises an independent first storage space; a plurality of independent first memory blocks are set in the first storage space; a first record comprising the preconfigured geographic location information is stored in each of the first memory blocks.

Preferably, mobile terminal settings switching system, wherein the storage module comprises an independent second storage space; a plurality of independent second memory blocks are set in the second storage space; a second record comprising the preconfigured geographic location information is stored in each of the second memory blocks; and each of the second records corresponds to one of the first records.

Preferably, mobile terminal settings switching system, wherein the positioning unit is a mobile network positioning unit, a wireless network positioning unit or a GPS positioning unit.

Preferably, mobile terminal settings switching system, wherein the storage module further comprises an independent third storage space; a plurality of independent third memory blocks are set in the third storage space; a third record comprising the preconfigured time information is stored in each of the third memory blocks; and each of the third records corresponds to one of the second records.

Preferably, mobile terminal settings switching system, further comprising: a timing module connected to the execution module;

the timing module is used for acquiring the current time information of the mobile terminal and sending it to the execution module; according to the time information, the execution module extracts the corresponding settings parameters set stored in the storage module and applies it to the mobile terminals.

Preferably, mobile terminal settings switching system, further comprising:

a control module connected to the positioning module and the storage module respectively;

the control module is used for acquiring the region positioning information of the mobile terminals and matching the region positioning information with the preconfigured geographic location information in the storage module;

if the geographic location information is not comprised in the region positioning information, the control module will turn off the positioning module;

if the geographic location information is comprised in the region positioning information, the control module will turn on the positioning module.

Preferably, mobile terminal settings switching system, wherein, in the condition that the positioning module works normally, if the geographic location information is comprised in the region positioning information, the control module will not execute any operation within the preconfigured second time interval.

Preferably, mobile terminal settings switching system, wherein the region positioning information is acquired by handling the LAC information, the RAC information or the Cell ID information which are acquired by the mobile terminals.

A mobile terminal, comprising: the mobile terminal settings switching system above.

The advantageous effects of the above technical solutions are those as follows:

1) the settings parameters of the mobile terminals are automatically switched by positioning the geographic location without the manual switching, which saves the operation time;

2) all the settings parameters are automatically executed, which improves the operating efficiency and the users' experiences;

3) the entire system is simple with low cost to implement.

### BRIEF DESCRIPTIONS OF THE DRAWINGS

The accompanying drawings, together with the specification, illustrate exemplary embodiments of the present disclosure, and, together with the description, serve to explain the principles of the present invention.

FIG. 1 shows a structure diagram of a mobile terminal settings switching system in a preferred embodiment of the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

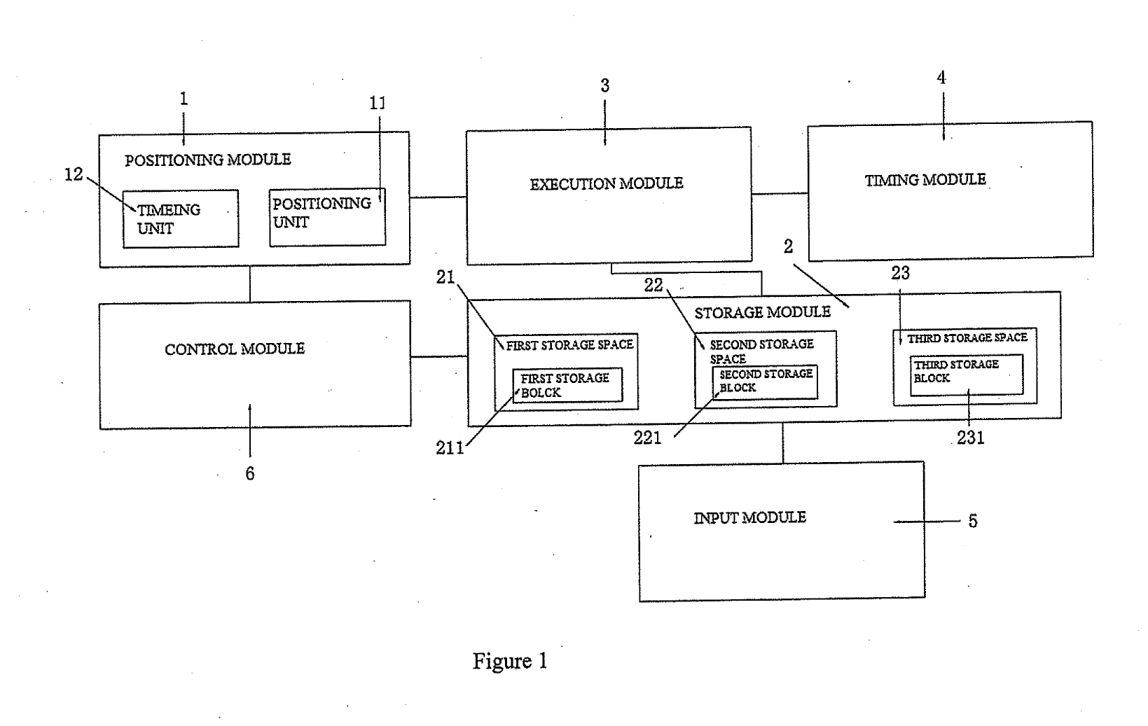

In the preferred embodiment of the present invention, as shown in FIG. 1, a mobile terminal settings switching system which is applied in the mobile terminals is provided. The mobile terminal settings switching system comprises a Positioning Module 1, a Storage Module 2 and an Execution Module 3. Storage Module 2 is connected to Positioning Module 1 and Execution Module 3 respectively.

In the preferred embodiment of the present invention, Storage Module 2 comprises an independent First Storage Space 21 which is provided with a plurality of independent First Memory Blocks 22 therein (Only one is presented in FIG. 1). In this embodiment, a first record including a preconfigured geographic location information is stored in each of First Memory Blocks 22.

In the preferred embodiment of the present invention, Storage Module 2 further comprises an independent Second Storage Space 22; a plurality of independent Second Memory Blocks 221 (Only one is presented in FIG. 1) are set in Second Storage Space 22. In this embodiment, a second record including a settings parameters set is stored in each of Second Memory Blocks 221. In this embodiment, each set of the settings parameters comprises a plurality of settings parameters. Furthermore, the parameters may comprise the parameter values of settings which are the notification ways of mobile terminals (alarm or vibration), notification bell, the on/off status of WiFi, GPS or Bluetooth, the mask status of the caller ID and so on.

In the preferred embodiment of the present invention, it is necessary to establish the corresponding relationship between the first record including the geographic location information and the second record including the preconfigured settings parameters sets.

In the preferred embodiment of the present invention, Positioning Module 1 comprises Positioning Unit 11 and Timing Unit 12; Positioning Unit II is connected to Timing Unit 12. Positioning Unit 11 is used for acquiring the current geographic location information of the mobile terminals through the positioning technology. In this embodiment, the geographic location information can be the information of latitude and longitude.

In the preferred embodiment of the present invention, a first time interval is preconfigured in Timing Unit 12, and the first time interval is adopted as the time period when Positioning Module 11 sends out the positioning request and collects the geographic location information, which saves the electric power of the mobile terminal.

In the preferred embodiment of the present invention, Positioning Unit 11 could be a mobile network positioning unit, a wireless network positioning unit or a GPS positioning unit. In other words, in this embodiment, the positioning technology of the mobile terminal settings switching system may adopt the mobile network positioning technology, the wireless network positioning technology, or the GPS positioning technology. In a preferred embodiment of the present invention, the above three technologies can be adopted to positioning simultaneously, that is, Positioning Unit 11 comprises the mobile network positioning unit, the wireless network positioning unit and the GPS positioning unit. While positioning, Positioning Unit 11 can work according to the priorities. In this embodiment, for example, the GPS positioning unit owns the highest priority, the wireless network positioning unit owns the second priority, and the mobile network positioning unit owns the lowest priority. When the GPS positioning unit can not receive the CPS positioning information, or when the GPS positioning unit is failed to work normally, the wireless network positioning unit will be applied to positioning. Moreover, the mobile network positioning unit would be applied to performing the positioning while the wireless connection does not exist.

On the basis of the above embodiment, the descriptions of the present invention have been presented for purposes of description and illustration, but are not intended to be exhaustive or limited to the embodiments disclosed. Many modifications and variations will be apparent to those of ordinary skill in the art. The positioning technique that is well known by the people skilled in the art can be applied to the positioning unit of the mobile terminals achieve the purpose of the present invention.

In the embodiment of the present invention, the mobile terminals settings switching system further comprises a Timing Module 4. Timing Module 4 is connected to Execution Module 3. In this embodiment, Timing Module 4 is used for acquiring the current time information of the mobile terminals. And the current time information is sent to Execution Module 3 by Timing Module 4.

In the embodiment of the present invention, as Timing Module 4 is set in the mobile terminal settings switching system, correspondingly, an independent Third Storage Space 23 is set in Storage Module 2. A plurality of independent Third Memory Blocks 231 (Only one is presented in FIG. 1) is set in Third Storage Space 23. A third record including the preconfigured time information is stored in each of Third Memory Blocks 231. In this embodiment, each of the third record including the preconfigured time information is corresponding to one of the second record including the preconfigured settings parameters sets.

In the embodiment of the present invention, there is a plurality of trigger conditions (the changes of the geographic location information or the changes of the time information) which can result in the change of the settings parameters of mobile terminals. Therefore, in Storage Module 2, the map way which is several-for-one is adopted, that is, several trigger conditions correspond (i.e., the first record comprising the geographic location information, and the third record comprising the time information) to one trigger result (i.e., the second record comprising the settings parameters set). In this embodiment, if there is only one trigger condition (i.e., the first record comprising the geographic location information), the trigger conditions will have a one-to-one corresponding relation with the trigger results (i.e., the second record comprising a settings parameters set).

In the preferred embodiment of the present invention, the mobile terminal settings switching system further comprises an Input Module 5. Input Module 5 is connected to Storage Module 2. Input Module 5 is supplied for users to input the preconfigured geographic location information and the time information, and to input the corresponding settings parameters to form the set of the settings parameters. The geographic location information, the time information and the settings parameters sets are stored in the corresponding storage space of Storage Module 2.

In the embodiment of the present invention, various forms of Input Module 5 can be presented according to different input contents. For instance, the input of the geographic location information can be realized by the way that users mark the place in the virtual map, when a map operation interface is shown on the display screen. It also can be achieved by inputting the information which comprises the name of specific geographic location, the latitude and longitude, and other information that can indicate the geographic location. The above geographic locations based on the different input information are treated to form the corresponding geographic location information, and the corresponding geographic location information will be store in Storage Module 2.

In the embodiment of the present invention, the input of the time information can be realized by the way that choosing the specific time at the electronic calendar or electronic clock of mobile terminals to form the corresponding time information. The time information is stored in Storage Module 2 by Input Module 5.

In the embodiment of the present invention, the input of the settings parameters can be realized by a system settings interface of the mobile terminals, or by a comprehensive interface to set various configuration operation of the system.

In the embodiment of the present invention, with regard to the above-mentioned preconfigured geographic location information, the time information and the settings parameters, an associated operation interface can be employed for configuring the corresponding relation thereof, so that the final procedure of configuring the system can be accomplished.

In the embodiment of the present invention, the switching system of mobile terminals further comprises a Control Module 6. Control Module 6 is connected to Positioning Module 1 and Storage Module 2 respectively, In this embodiment, Control Module 6 is used for controlling the working condition of Positioning Module 1. Control Module 6 could acquire the region positioning information of the mobile terminals when the mobile terminal initiated. In this embodiment, the region positioning information could be the LAC (location area code), the RAC (relative address coding) or the Cell ID. The LAC, the RAC and the Cell ID are the region positioning information acquired when the mobile terminal starts to work. The region positioning information has been limited to a lager positioning range. The Cell ID is corresponding to the cell area where the mobile terminal is located, the RAC is corresponding to the routing area where the mobile terminal is located, and the LAC is corresponding to the location area where the mobile terminal is located. Consequently, the positioning range to which the Cell ID is corresponding is the smallest one, the positioning range to which the RCD is corresponding is the secondary, the positioning range to which the LCD is corresponding is the largest one. To position the geographic location of mobile terminals, firstly, Control Module 6 acquires the LAC, the RAC or the Cell ID. In a preferred embodiment of the present invention, Control Module 6 can also acquire the LAC, the RAC and the Cell ID. Secondly, Control Module 6 acquires the region positioning information of the mobile terminal and matches the region positioning information with the preconfigured geographic location information in Storage Module 2.

If the geographic location information stored in Storage Module 2 is not in the area which is positioned via the region positioning information (i.e., not match), it indicates that the preconfigured geographic location is not in the area where the mobile terminal is located. Therefore, Control Module 6 turns off Positioning Module 1; if the geographic location information stored in Storage Module 2 is in the area which is positioned by the region positioning information (i.e., already match), it indicates that the preconfigured geographic location is in the area where mobile terminal is located. Therefore, Control Module 6 turns on Positioning Module 1. Alternatively, there is no operation within the preconfigured second time interval when Positioning Module 1 is working. As the network planning will be changed by the time passing, and the time interval will be long, in the preferred embodiment of the present invention, the time interval of the network planning change may be a week or a month. Accordingly, the preconfigured second time interval could be configured as the time interval corresponding to the altering time. At this moment, Positioning Module 1 begins to perform a further positioning so as to narrow down the positioning range, to improve the positioning accuracy, and to acquire the corresponding geographic location information of the mobile terminal.

In the embodiment of the present invention, when Execution Module 3 acquires the geographic location information, Execution Module 3 matches the geographic location information with the preconfigured geographic location information stored in Storage Module 2. Afterwards, Execution Module 3 executes the corresponding operation. If the acquired geographic location information matches with the preconfigured geographic location information stored in Storage Module 2, Execution Module 3 will take a set of the settings parameters corresponding to the geographic location information in Storage Module 2, and the set of the settings parameters would be applied to the mobile terminals.

If the acquired geographic location information does not match with the preconfigured geographic location information stored in Storage Module 2, then Execution Module 3 will not execute any operation.

In the embodiment of the present invention, when Execution Module 3 acquires the above time information, Execution Module 3 matches the time information with the preconfigured time information that stores in Storage Module 2. Afterwards, Execution Module 3 will execute the operation according to the matching result;

If the acquired time information matches with the preconfigured time information stored in Storage Module 2, then Execution Module 3 will take a set of the settings parameters corresponding to the time information in Storage Module 2, and apply the set of the settings parameters to the mobile terminals.

If the acquired time information does not match with the preconfigured time information stored in Storage Module 2, Execution Module 3 will not execute any operation.

In the embodiment of the present invention, Execution Module 3 can perform the matching operation to the geographic location information and the time information simultaneously, and according to the first record comprising geographic location information and the third record comprising time information, Execution Module 3 can take and apply the corresponding second record comprising settings parameter sets to the mobile terminal. In this embodiment, when a geographic location information and a time information are satisfied simultaneously, there will be an interference between the a second record corresponding to the first record comprising the geographic location information and a second record corresponding to the third record comprising the time information, so a priority sequence of the above geographic location information and the time information may be preconfigured. In this embodiment, if the priority of the geographic location information is higher than that of the time information, when the mobile terminals receive the geographic location information and the time information simultaneously, and if the second record corresponding to the first record comprising the geographic location information interferes the second record corresponding to the third record comprising the time information, the set of the settings parameters in the second record corresponding to the first record will be applied to the mobile terminals. In another embodiment, if the priority of the time information is higher than that of the geographic location information, when the mobile terminals receive the geographic location information and the time information simultaneously, and if the second record corresponding to the first record comprising the geographic location information interferes the second record corresponding to the third record comprising the time information, the set of the settings parameters in the second record corresponding to the third record will be applied to the mobile terminals.

While the present disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A mobile terminal settings switching system, which is applied to mobile terminals, comprises a positioning module, a storage module and an execution module;
the execution module is connected to the positioning module and the storage module respectively;
the positioning module means for acquiring the current geographic location information of the mobile terminals;
a plurality of settings parameters sets corresponding to each of the geographic location information are stored by the storage module;
each of the settings parameters sets comprises a plurality of corresponding parameters;
according to the geographic location information acquired by the positioning module, the execution module extracts the corresponding set of the settings parameters stored by the storage module, and the set of the corresponding parameters is applied to the mobile terminals.

2. The system as disclosed in claim 1, wherein the positioning module comprises a positioning, unit and a timing unit; the positioning unit is connected to the timing unit; the positioning unit is used for positioning the mobile terminals to acquire the corresponding geographic location information; a preconfigured first time interval is provided in the timing unit; the positioning unit acquires the geographic location information of the mobile terminals at every preconfigured first time interval.

3. The system as disclosed in claim 1, further comprising: an input module connected to the storage module; the input module is supplied for the users to set the geographic location information and to set the set of settings parameters which corresponds to the geographic location information; the geographic location information and the set of settings parameters corresponding to the geographic location information are stored in the storage module by the input module.

4. The system as disclosed in claim 1, wherein the storage module comprises an independent first storage space; a plurality of independent first memory blocks are set in the first storage space; a first record comprising the preconfigured geographic location information is stored in each of the first memory blocks.

5. The system as disclosed in claim 4, wherein the storage module comprises an independent second storage space; a plurality of independent second memory blocks are set in the second storage space; a second record comprising the preconfigured geographic location information is stored in each of the second memory blocks; and each of the second records corresponds to one of the first records.

6. The system as disclosed in claim 2, wherein the positioning unit is a mobile network positioning unit, a wireless network positioning unit or a GPS positioning unit.

7. The system as disclosed in claim 5, wherein the storage module further comprises an independent third storage space; a plurality of independent third memory blocks are set in the third storage space; a third record comprising the preconfigured time information is stored in each of the third memory blocks; and each of the third records corresponds to one of the second records.

8. The system as disclosed in claim 7, further comprising: a timing module connected to the execution module;
the timing module is used for acquiring the current time information of the mobile terminal and sending it to the execution module; according to the time information, the execution module extracts the corresponding settings parameters set stored in the storage module and applies it to the mobile terminals.

9. The system as disclosed in claim 4, further comprising:
a control module connected to the positioning module and the storage module respectively;
the control module is used for acquiring the region positioning information of the mobile terminals and matching the region positioning information with the preconfigured geographic location information in the storage module;
if the geographic location information is not comprised in the region positioning information, the control module will turn off the positioning module;
if the geographic location information is comprised in the region positioning information, the control module will turn on the positioning module.

10. The system as disclosed in claim 9, wherein, in the condition that the positioning module works normally, if the geographic location information is comprised in the region positioning information, the control module will not execute any operation within the preconfigured second time interval.

11. The system as disclosed in claim 10, wherein the region positioning information is acquired by handling the LAC information, the RAC information or the Cell ID information which are acquired by the mobile terminals.

12. A mobile terminal comprises a mobile terminal settings switching system, which is applied to mobile terminals, comprising a positioning module, a storage module and an execution module;
the execution module is connected to the positioning module and the storage module respectively;
the positioning module means for acquiring the current geographic location information of the mobile terminals;
a plurality of settings parameters sets corresponding to each of the geographic location information are stored by the storage module;
each of the settings parameters sets comprises a plurality of corresponding parameters;
according to the geographic location information acquired by the positioning module, the execution module extracts the corresponding set of the settings parameters stored by the storage module, and the set of the corresponding parameters is applied to the mobile terminals.
